(19) United States
(12) Patent Application Publication
(10) Pub. No.: US 2025/0062398 A1
(43) Pub. Date: Feb. 20, 2025

(54) COMPOSITE SOLID-STATE ELECTROLYTES, DEVICES WITH COMPOSITE SOLID-STATE ELECTROLYTES, AND METHODS FOR FABRICATION THEREOF

(71) Applicant: UNIVERSITY OF MARYLAND, COLLEGE PARK, College Park, MD (US)

(72) Inventors: Liangbing HU, Rockville, MD (US); Weiwei PING, Hyattsville, MD (US); Qi DONG, Newton, MA (US); Min HONG, Hyattsville, MD (US)

(21) Appl. No.: 18/721,559

(22) PCT Filed: Dec. 22, 2022
(86) PCT No.: PCT/US22/53768

§ 371 Date: Jun. 18, 2024

Related U.S. Application Data
(60) Provisional application No. 63/265,857, filed on Dec. 22, 2021.

(51) Int. Cl. H01M 10/0562

(52) U.S. Cl. CPC H01M 10/0562; H01M 2300/0071; H01M 2300/0094

(57) ABSTRACT

Precursors can be provided on a surface of a porous support layer and subjected to a temperature≤1200 K for a time≤60 seconds, so as to sinter the precursors into a porous scaffold. The porous scaffold can comprise an ion-conducting oxide. Filler materials can be provided on a surface of the porous scaffold. The filler materials can have a melting point in a range of 500-1100 K. The porous scaffold with filler materials can be subjected to a temperature≤1200 K for a time≤50 seconds, so as to melt the filler materials to form a non-porous composite solid-state electrolyte layer, with the filler materials infiltrating the porous scaffold. The solid-state electrolyte layer can be incorporated into a solid-state electrochemical energy device, such as a battery or fuel cell.

### CROSS-REFERENCE TO RELATED APPLICATION

The present application claims the benefit of U.S. Provisional Application No. 63/265,857, filed Dec. 22, 2021, entitled “High-Performance Multilayer Solid-State Electrolytes,” which is incorporated by reference herein in its entirety.

### STATEMENT REGARDING FEDERALLY SPONSORED RESEARCH

This invention was made with government support under W911NF2020284 awarded by the U.S. Army Research Laboratory (ARL). The government has certain rights in the invention.

### FIELD

The present disclosure relates generally to solid-state structures, and more particularly, to composite solid-state electrolytes, for example, for use in batteries (e.g., solid-state batteries) or solid oxide cells (e.g., solid oxide fuel cells and/or solid oxide electrolysis cells).

### BACKGROUND

Solid-state electrolytes (SSEs) formed by ion-conducting ceramics have been contemplated for use in next generation lithium (Li) ion battery technologies, for example, to provide enhanced safety and higher energy densities. To this end, a range of ceramic SSEs have been developed that exhibit high ionic conductivity (e.g., up to 10⁻³ S/cm), a wide electrochemical window (e.g., up to 6 V), good chemical stability (e.g., against Li metal), and excellent mechanical properties (e.g., mechanical strength up to 20 GPa). However, there remain issues that have hindered adoption of SSEs for all-solid-state batteries.

First, it is generally improbable for a single composition for the SSE to satisfy all requirements for efficient operation. For example, LLTO, LiTi₂(PO₄)₃, Li₁₄Zn(GeO₄)₄ have poor chemical stability with Li metal. In addition, sulfides (e.g., Li₂S—P₂S₅, Li₂S—P₂S₅—MSₓ) and hydrides (e.g., LiBH₄, LiBH₄—LiX (X=Cl, Br, or I)) can have poor compatibility with cathode materials. Halides (e.g., LiI, spinel Li₂ZnI₄ and anti-perovskite Li₃OCl), borates or phosphates (e.g., Li₂B₄O₇, Li₃PO₄ and Li₂O—B₂O₃—P₂O₅), and LiPON have a low conductivity of 10⁻⁸-10⁻⁵ S/cm. Garnet Li₂La₃Zr₂O₁₂ can have interfacial stability issues with certain cathode materials (e.g., LiCoO₂), which can result in increased interface resistance. The use of coatings has been ineffective at fully addressing such issues.

In addition, because of the large energy of the ceramics Li-ion conductors, SSEs have to be formed as a thin film (e.g., tens of micron) so as to achieve high energy densities at the full cell level. However, such thin-film ceramic SSEs can be challenging to process. Due to the brittleness of most ceramic Li-ion conductors, the thin-film SSEs need to be supported on a suitable substrate. Such supports present a significant constraint to the electrochemical energy cell configuration, since the support will need to be integrated into the cell assembly process. In addition, the materials for supporting the SSE may be incompatible with some electrochemical energy devices or may result in SSE cracking during conventional sintering due to mismatch in thermal expansion coefficients.

Embodiments of the disclosed subject matter may address one or more of the above-noted problems and disadvantages, among other things.

### SUMMARY

Embodiments of the disclosed subject matter system provide composite solid-state electrolytes (SSEs) for use in electrochemical energy devices, such as solid-state batteries or solid-oxide fuel cells, as well as methods for fabrication thereof. In some embodiments, the composite SSE can be a porous scaffold formed on a porous support, for example, a porous carbon or metal layer. The porous scaffold can be infiltrated with a low-melting point glassy ion conductor to form a composite. In some embodiments, the composite SSE can be formed using a two-step heating process (e.g., heating wave) of short duration (e.g., ≤60 seconds) and limited high temperature (e.g., ≤1200 K). The two-step heating process can avoid cracking of the SSE while still forming a dense, pinhole-free (e.g., nonporous layer). Alternatively or additionally, in some embodiments, the composite SSE can include multiple sublayers of different composition. In some embodiments, each SSE sublayer can be formed by a heating process (e.g., heating wave) of short duration (e.g., ≤60 s) and high sintering temperature (e.g., up to 3000 K). In some embodiments, the limited duration of the heating process can avoid elemental co-diffusion while still forming a dense ceramic structure for the SSE.

In one or more embodiments, a method can comprise providing one or more precursors on a first surface of a porous support layer. The method can further comprise subjecting the porous support layer with one or more precursors to a first temperature for a first time so as to sinter the one or more precursors to form a porous scaffold. The first temperature can be less than or equal to about 1200 K. The first time can be less than or equal to about 60 seconds. The porous scaffold can comprise an ion-conducting oxide. The method can also comprise providing one or more filler materials on a second surface of the porous scaffold. The one or more filler materials can have a melting point in a range of 500-1100 K, inclusive. The method can further comprise subjecting the porous scaffold with the one or more filler materials to a second temperature for a second time so as to melt the one or more filler materials to form a non-porous composite solid-state electrolyte layer with the one or more filler materials infiltrating the porous scaffold. The second temperature can be less than or equal to about 1200 K, and the second time can be less than or equal to about 60 seconds.

In one or more embodiments, an electrochemical energy device can comprise a porous support layer and a non-porous, composite solid-state electrolyte layer. The non-porous, composite solid-state electrolyte layer can be disposed on the porous support layer and can comprise a porous scaffold and one or more filler materials infiltrating the porous scaffold. The porous scaffold can comprise an ion-conducting oxide. The one or more filler materials can have a melting point in a range of 500-1100 K, inclusive. At least a portion of the porous support layer can be infiltrated with one or more materials to form an electrode of the electrochemical energy device. In some embodiments, the electrochemical energy device is a solid-state battery.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIGS. 1A-1C are simplified schematic diagrams of systems employing batteries formed using porous support layers, according to one or more embodiments of the disclosed subject matter.

FIG. 2A is a simplified schematic diagram illustrating aspects for fabricating a non-porous, composite solid-state electrolyte, according to one or more embodiments of the disclosed subject matter.

FIGS. 2B-2D are simplified schematic diagrams illustrating aspects for fabricating layer assemblies of a battery, according to one or more embodiments of the disclosed subject matter.

FIG. 3 is a process flow diagram for fabricating a layer assembly of a battery, according to one or more embodiments of the disclosed subject matter.

FIG. 4A is a graph illustrating an exemplary temperature profile for sintering via thermal shock.

FIG. 4B depicts a generalized example of a computing environment in which the disclosed technologies may be implemented.

FIG. 5A is a digital image of a tantalum-doped Li₂La₃Zr₂O₁₂ (LLZTO) porous scaffold formed on a carbon-nanotube (CNT) porous support layer.

FIGS. 5B-5C are scanning electron microscopy (SEM) images of the LLZTO porous scaffold of FIG. 5A.

FIG. 5D is an SEM image of an interface between the LLZTO porous scaffold and the CNF porous support layer of FIG. 5A.

FIG. 6A is a digital image of a non-porous composite solid-state electrolyte (SSE) formed by infiltrating Li₃BO₃ (LBO) glass into the LLZTO porous scaffold of FIG. 5A.

FIGS. 6B-6C are SEM images of the LLZTO/LBO composite SSE of FIG. 6A.

FIG. 6D is an SEM image of an interface between the LLZTO/LBO composite SSE and the CNF porous support layer of FIG. 6A.

FIG. 7A is a simplified cross-sectional view of an asymmetric cell for testing of the LLZTO/LBO composite SSE.

FIG. 7B is a graph showing X-ray diffraction (XRD) analysis of the LLZTO/LBO composite SSE.

FIG. 7C is a graph showing measured ionic conductivities of the LLZTO/LBO composite SSE.

FIG. 7D is a graph showing results of galvanostatic cycling of the asymmetric cell of FIG. 7A at 0.2 mA/cm².

FIG. 8A is a graph illustrating computed electrochemical windows for different SSE compositions.

FIG. 8B is a graph illustrating widening of electrochemical windows via multilayer SSEs.

FIGS. 8C-8D are SEM images of a cross-section of a fabricated multilayer SSE formed by a thin film of LiBO₂ on LLZTO.

FIG. 9A is a graph illustrating widening of an electrochemical window for a multilayer SSE formed by NASICON-type Li_{1.3}Al_{0.3}Ti_{1.7}(PO₄)₃ (LATP) on garnet-type LLZTO.

FIG. 9B is a graph showing XRD analysis for the fabricated LATP layer as compared to a pure NASICON-type structure.

FIGS. 9C-9D are SEM images of a cross-section of a fabricated multilayer SSE formed by a thin film of LATP on LLZTO.

FIG. 10A is a graph illustrating widening of an electrochemical window for a multilayer SSE formed by a LiBO₂—Li₃PO₄ layer formed on pervoskite-type Li_{0.33}La_{0.57}TiO₃ (LLTO).

FIGS. 10B-10C are SEM images of a cross-section of a fabricated multilayer SSE formed by layers of LiBO₂—Li₃PO₄ and LLTO on a lithium anode.

FIG. 10D is an SEM image of an interface between the Li anode and the LiBO₂—Li₃PO₄ layer.

FIG. 10E is an SEM image of an interface between the LiBO₂—Li₃PO₄ layer and the LLTO layer.

FIGS. 11A-11B are SEM images of a cross-section of a fabricated multilayer SSE formed by Li₃PO₄ (LPO) on LLZTO.

FIG. 11C is a graph showing XRD analysis for LPO on LLZTO and LiBO₂ (LBO) on LLZTO.

FIGS. 11D-11E are graphs showing measured ionic conductivities and activation energy, respectively, of a bilayer SSE formed by LBO on LLZTO.

FIG. 11F is a graph showing the relationship of resistance versus thickness of a bilayer SSE.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following is provided to facilitate the description of various aspects of the disclosed subject matter and to guide those skilled in the art in the practice of the disclosed subject matter.
Heating Wave: Subjecting one or more materials to a high temperature for a limited time period having a duration less than or equal to about 60 s in order to effect melting and/or sintering thereof. In some embodiments, the duration of the high temperature is less than 30 s, for example, in a range of 3-10 s, inclusive. For example, in some embodiments, the duration can be about 5 s. In some embodiments, the subjecting may involve heating to the high temperature at a ramp rate of at least 10³ K/s (e.g., about 10⁵ K/s) prior to the limited time period, and/or cooling from the high temperature at a ramp rate of at least 10³ K/s (e.g., about 10⁵ K/s) after the limited time period.
High temperature: A peak or maximum temperature at a surface of one or more heating elements when energized (e.g., by application of a current pulse) and/or at a surface of a material being heated. In some embodiments, the high temperature is less than 1200 K, for example, about 1100 K. Alternatively, in some embodiments, the high temperature is in a range of 1200-3000 K. In some embodiments, a temperature at a material being heated (e.g., precursors) can match or substantially match (e.g., within 10%) the temperature of the heating element.
NASICON: Sodium-based super ionic conductors, for example, having a chemical formula of Na₁₊ₓZr₂SiₓP₃₋ₓO₁₂, where 0<x<3. In some embodiments, Zr, Si, and/or Na in the chemical formula can be replaced by an isovalent element, such as V, Sb, or Ta.
LISICON: Lithium-based super ionic conductor, for example, having a chemical formula of Li₂₊₂ₓZn₁₋ₓGeO₄.

### Introduction

Disclosed herein are composite solid-state structures formed by sintering, which composite structures would otherwise be unattainable by conventional sintering techniques due to layer cracking and/or interlayer diffusion of elements. In some embodiments, the composite solid-state structure can be formed as an ion conductor, for example, to conduct metal ions (e.g., alkali metal ions, such as lithium (Li) ions, sodium (Na) ions, potassium (K) ions, etc., and/or alkaline earth metal ions, such as magnesium (Mg) or calcium (Ca)) or anions (e.g., oxygen (O) ions). One or more layers of the composite solid-state structure can be formed of a material composition satisfying a chemical formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, where 4<A<8.5, 1.5<B<4, 0≤C≤2, 0≤D≤2, 0≤E<2, and 10<F<13, M′ is a first one selected from Al, Mo, W. Nb, Sb, Ca, Ba, Sr. Ce, Hf, Rb, or Ta, and M″ is a second one selected from Al, Mo, W. Nb, Sb, Ca, Ba, Sr, Ce, Hf, Rb, or Ta. Alternatively, in some embodiments, one or more layers of the composite solid-state structure can be formed of a material composition satisfying a chemical formula of Li_{A}La_{B}Zr_{C}Al_{D}M″_{E}O_{F}, where 5<A<7.7, 2<B<4, 0<C≤2.5, 0≤D<2, 0≤E<2, and 10<F<13, and M″′ is Nb, Ta, V, W, Mo, or Sb. For example, the composite solid-state structure can include at least one layer having a material composition selected from the group consisting of perovskite-type Li₃ₓLa_{2/3-x}TiO₃ (LLTO), NASICON-type LiTi₂(PO₄)₃, NASICON-type Li_{1.3}Al_{0.3}Ti_{1.7}(PO₄)₃, NASICON-type Li₁₊ₓAlₓGe₂₋ₓ(PO₄)₃, garnet-type Li₂La₃Zr₂O₁₂ (LLZO), garnet-type Li₂La₃Zr_{1.4}Ta_{0.6}O₁₂ (LLTZO), LISICON-type Li₁₄Zn(GeO₄)₄, thio-LISICON-type Li₄₋ₓGe₁₋ₓPₓS₄, argyrodite-type Li₆PS₅Cl, and anti-perovskite-type Li₃OCl.

In some embodiments, a composite solid-state structure can be formed by sintering a porous scaffold on a porous support layer. The sintering can be achieved by employing a high-temperature heating wave (e.g., ≤60 s in duration), enabled at least in part by fast temperature heating and/or cooling rates (e.g., ≥10³ K/s). Due to the short duration of applied heating (e.g., seconds as opposed to the several hours required by conventional sintering), the porous scaffold can be sintered on the porous support layer without cracking. In some embodiments, a filler material can then be melted to infiltrate the previously-sintered porous scaffold to form a dense layer, for example, a composite solid-state electrolyte for an electrochemical energy device (e.g., battery or fuel cell). The melting can be achieved by employing another high-temperature heating wave (e.g., ≤60 s in duration). In some embodiments, the porous support layer can be converted into an electrode of the electrochemical energy device, for example, by infiltrating with a metal (e.g., Li), electrocatalysts, or cathode active materials. In some embodiments, the material of the porous scaffold can have a melting temperature and/or a sintering temperature greater than the melting temperature of the filler material. For example, the material of the porous scaffold can have a melting temperature and/or sintering temperature greater than 1200 K, while the filler material can have a melting temperature less than 1200 K (e.g., a melting point in a range of 500-1100 K).

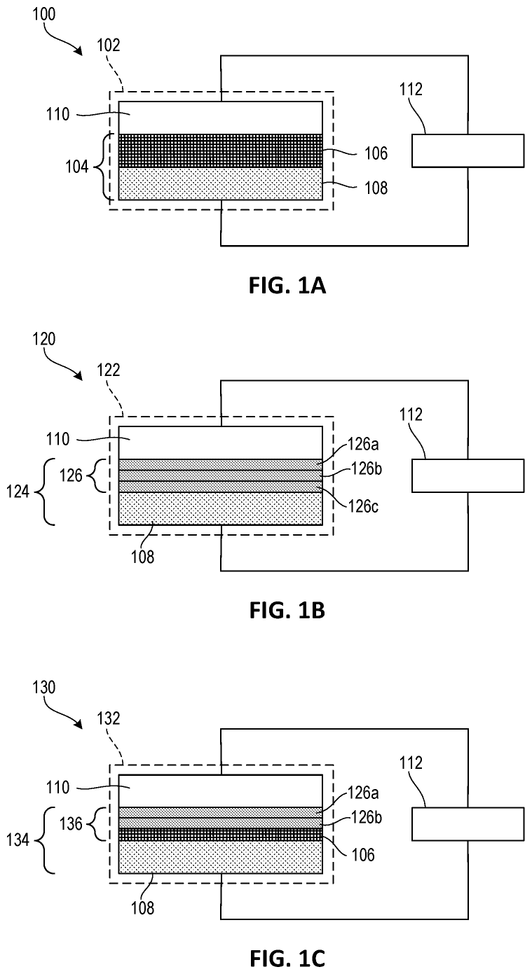

For example, FIG. 1A illustrates a composite solid-state electrolyte (SSE) 106 incorporated into a layer assembly 104 of a battery 102 (e.g., primary battery or secondary battery). The battery 102 can include a first electrode 110 and a second electrode 108 on opposite sides of the composite SSE 106 (e.g., having a thickness less than or equal to 500 μm, for example, in a range of 10-300 μm, such as 10-50 μm). Through the electrodes 108, 110, the battery 102 may be coupled via an appropriate electrical circuit to node 112, which may be an electrical load for use of charge stored by the battery or a power source for recharging the battery. In some embodiments, the battery 102 can be a Li ion battery.

In the illustrated example 100, the composite SSE 106 is formed by a porous scaffold infiltrated with one or more filler materials to yield a dense layer (e.g., nonporous). For example, the porous scaffold can be formed of an ion conducting ceramic material, and/or the filler material can be formed of a low-melting point ion conducting glassy material (e.g., LiBO₃, LiCl, LiBr, LiI, LiF, Li₃N, LiBH₄, LiBF₄). In some embodiments, the porous scaffold, the filler material, or both can include the element corresponding to the desired ion to be conducted, among other constituent elements. For example, when battery 102 is a Li-ion battery, the porous scaffold and/or the filler material can comprise Li. The material compositions for the composite SSE 106 (e.g., the material for the porous scaffold and/or the infiltration filler material) can be selected such that the SSE 106 has a high ionic conductivity (e.g., ≥˜1×10⁻³ S/cm) and a low electronic conductivity (e.g., ≤˜1×10⁻⁸ S/cm, such as ˜2×10⁻⁹ S/cm). For example, the porous scaffold and/or the filler material can have an ionic conductivity of at least 1×10⁻⁴ S/cm. Alternatively or additionally, the porous scaffold and/or the filler material composition can have an electronic conductivity of 1×10⁻⁸ S/cm or less.

In the illustrated example of FIG. 1A, the second electrode 108 is formed of a porous and conductive substrate (e.g., porous carbon, such as carbon black, or a porous metal layer, such as Cu foam, Ti mesh, Ni mesh, etc.) that is infiltrated with an electrically conductive metal. The porous substrate thus serves as a support for the composite SSE 106 in the layer assembly 104, as well as acting as an electrode of the battery 102. For example, when electrode 108 is configured as an anode of the battery 102, the porous substrate can be infiltrated with lithium. Alternatively, when electrode 108 is configured as a cathode of the battery 102, the porous substrate be infiltrated with cathode active materials. The thickness and porosity of the porous substrate can be tailored to meet the requirements of a particular application (e.g., a loading density of active materials). For example, the thickness of the porous substrate can be in a range of 100 μm and 1 mm, inclusive, the porosity can be up to 94% for carbon substrates, and/or the porosity can be up to 90% for metal substrates. In some embodiments, the first electrode 110 can be formed separate from the layer assembly 104 and subsequently coupled thereto to form battery 102. Alternatively or additionally, in some embodiments, the first electrode 110 can be integrally formed on the layer assembly 104 or with the SSE 106, for example, via the sintering method disclosed in International Publication No. WO 2020/236767, published Nov. 26, 2020 and entitled “High temperature sintering systems and methods,” which is incorporated herein by reference.

Alternatively or additionally, in some embodiments, a composite solid-state structure can be formed of multiple layers (e.g., 2 or more) with different material compositions. In some embodiments, a subsequent layer can be sintered on a previously-formed layer, for example, via a high-temperature heating wave (e.g., ≤60 s in duration). Due to the short duration of applied heating, the layers can be formed atop each other without discernible interlayer diffusion of elements and with well-defined interfaces between adjacent layers. In some embodiments, the multilayer solid-state structure is formed as a solid-state electrolyte for an electrochemical energy device. In some embodiments, the multiple layers can be formed on a support layer, for example, a porous support layer.

For example, FIG. 1B illustrates a composite SSE 126 incorporated into a layer assembly 124 of a battery 122 (e.g., primary battery or secondary battery). The battery 122 can include a first electrode 110 and a second electrode 108 on opposite sides of the composite SSE having multiple layers 126a-126c. Although three layers 126a-126c are shown in FIG. 1B, two layers or four or more layers are also possible according to one or more contemplated embodiments. In some embodiments, each layer 126a-126c in the SSE stack can have a thickness greater than or equal to 1 μm, and/or a total thickness of the SSE stack of multiple layers 126a-126c can be greater than or equal 10 μm. Through the electrodes 108, 110, the battery 122 may be coupled via an appropriate electrical circuit to node 112, which may be an electrical load for use of charge stored by the battery or a power source for recharging the battery. In some embodiments, the battery 122 can also be a Li ion battery.

In some embodiments, at least some of the multiple layers 126a-126c can have different material compositions, for example, to widen an electrochemical voltage window of the SSE and/or to increase stability of the SSE against an adjacent electrode 108 and/or 110. For example, at least one of the layers 126a-126c can be formed of an oxide (e.g., perovskite Li_{0.33}La_{0.57}TiO₃, NASICON LiTi₂(PO₄)₃, LISICON (Li₁₄Zn(GeO₄)₄), garnet Li₂La₃Zr₂O₁₂, etc.), a sulfide (e.g., Li₂S—P₂S₅, Li₂S—P₂S₅—MSₓ, etc.), a hydride (e.g., LiBH₄, LiBH₄—LiX, where X is Cl, Br, or I, LiBH₄—LiNH₂, LiNH₂, Li₃AlH₆, Li₂NH, etc.), a halide (e.g., LiI, spinel Li₂ZnI₄, anti-perovskite Li₃OCl, etc.), or a borate or phosphate (e.g., Li₂B₄O₇, Li₃PO₄, Li₂O—B₂O₃—P₂O₅, etc.).

In some embodiments, each layer 126a-126c of the SSE can be formed via sequential high-temperature sintering, for example, by application of a high-temperature heating wave to precursors disposed on an underlying layer (e.g., support or previously sintered SSE layer). For example, each layer 126a-126c of the SSE can be made with controlled degree of densification (e.g., porous or dense) owing to the tunability of the heating wave technique. In the illustrated example 120 of FIG. 1B, the bottom SSE layer 126c is formed on second electrode 108, which is formed of a porous and conductive substrate (e.g., porous carbon, such as carbon black, or a porous metal layer, such as Cu foam, Ti mesh, Ni mesh, etc.) that is infiltrated with an electrically conductive metal. The porous substrate thus serves as a support for the SSE layers 126a-126c in the layer assembly 124, as well as acting as an electrode of the battery 102. In some embodiments, the first electrode 110 can be formed separate from the layer assembly 124 and subsequently coupled thereto to form battery 102. Alternatively or additionally, in some embodiments, the first electrode 110 can be integrally formed on the layer assembly 124 or with the SSE layer 126a, for example, via the sintering method disclosed in International Publication No. WO 2020/236767, incorporated above.

In some embodiments, the infiltrated porous scaffold of FIG. 1A and the multi-layer aspects of FIG. 1B can be combined together to form a composite solid-state structure, for example, a filler-infiltrated porous scaffold formed atop a porous support layer as well as one or more additional layers of different material compositions formed over the porous scaffold. For example, FIG. 1C illustrates a composite SSE 136 incorporated into a layer assembly 134 of battery 132 (e.g., primary battery or secondary battery). As with the other examples described above, the battery 132 (e.g., Li ion battery) can include a first electrode 110 and a second electrode 108 on opposite sides of the composite SSE that connect the battery 132 to node 112. Here, however, the composite SSE is formed by a filler-infiltrated porous scaffold layer 106 and multiple additional layers 126a-126b atop layer 106. Although two layers 126a-126b are shown in FIG. 1C, one layer or three or more layers are also possible according to one or more contemplated embodiments.

Although specific material compositions have been mentioned above and elsewhere herein, embodiments of the disclosed subject matter are not limited thereto. Rather, other material compositions are also possible according to one or more contemplated embodiments, for example, to accommodate different ions for conduction, to provide different performance metrics (e.g., higher ionic conductivity and/or lower electronic conductivity), to provide different fabrication limits (e.g., different melting points and/or sintering temperatures), to provide different mechanical properties (e.g., mechanical strength), or for any other reason

### Solid-State Electrolytes Formed Using Porous Support Layers

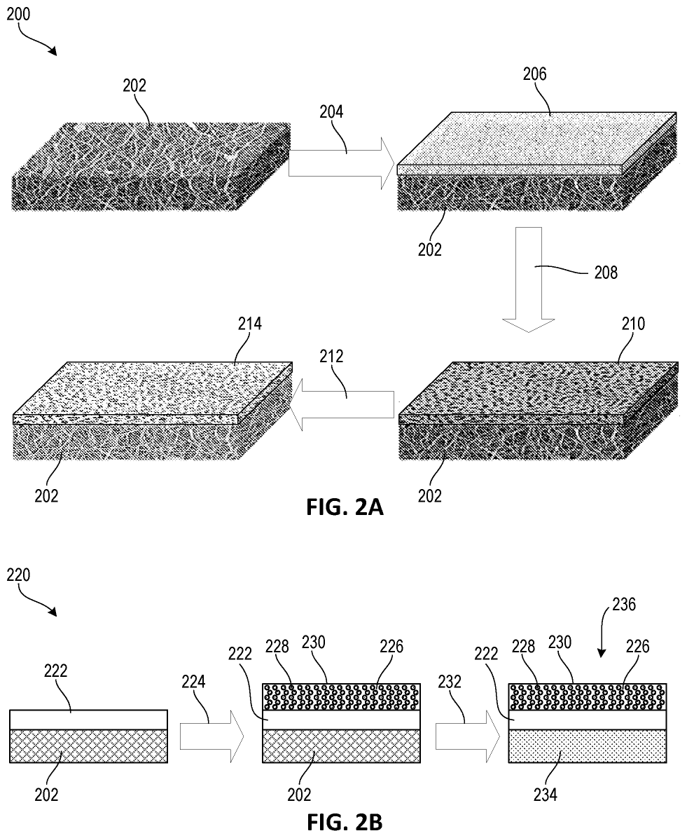

FIG. 2A illustrates a two-step heating wave process 200 for forming composite SSEs. A porous support layer 202 is initially provided. In some embodiments, the porous support layer 202 is formed of a conductive material, such as carbon or metal. For example, in some embodiments, the porous support layer 202 can be formed of conductive carbon particles or structures, such as a matrix of carbon nanotubes (CNTs). Alternatively, in some embodiments, the porous support layer 202 can be formed of a metal mesh or foam, such as Cu foam, Ti mesh, or Ni mesh. At 204, one or more precursors can be provided over the porous support layer, e.g., via known deposition technique, such as but not limited to spray coating, blade coating, printing, or tape transfer. This yields a precursor layer 206 over the porous support layer 202, which can then be sintered at 208 by application of a high-temperature heating wave to integrally form a porous scaffold 210 on the porous support layer 202. For example, the porous scaffold 210 can be formed of a material that conducts metal ions or anions, as described in detail above and elsewhere herein.

In some embodiments, the high-temperature heating wave is at a temperature less than that typically employed to sinter the precursors into a dense (e.g., nonporous) film. For example, conventional sintering may employ temperatures in excess of 1400 K to sinter a layer of LLZTO, but the heating wave of 208 may employ a temperature less than 1200 K, such as about 1100 K. In addition, the high-temperature heating wave has a duration substantially less than that typically employed in sintering. For example, conventional sintering may require hours or at least minutes, while the heating wave of 208 is performed for a duration of less than 30 seconds, such as about 5 seconds. In some embodiments, to accommodate different thermal expansion coefficients between the porous support layer and the precursors, the degree of sintering was controlled to maintain a porous morphology for the scaffold 210 with limited shrinkage but enough neck growth for continuous Li-ion conducting pathways. Due to the limited size change of the porous SSE during the short-duration sintering, the formation of cracks can be avoided, or at least reduced.

The porous scaffold 210 can then be infiltrated with one or more filler materials at 212 to yield a dense, nonporous layer 214 as composite SSE atop the porous support layer 202. In some embodiments, the filler infiltrate 212 can include depositing one or more filler materials (or precursors thereof) on the porous scaffold 210 and then applying another high-temperature heating wave. The deposition of filler materials on the porous scaffold 210 can be via any known deposition technique, such as but not limited to spray coating, blade coating, and vapor deposition. In some embodiments, the filler material is a glassy material (e.g., LBO) having a low melting point (e.g., a melting point in a range of 500-1100 K). For example, the filler can be formed of a material that conducts metal ions or anions, as described in detail above and elsewhere herein.

The high-temperature heating wave for infiltration 212 can be similar to that for sintering 208, for example, at a temperature less than 1200 K (e.g., ˜1100 K) and a duration less than 30 seconds (e.g., ˜5 seconds). Alternatively, the high-temperature heating wave of infiltration 212 can be different than that of sintering 208, for example, at a temperature lower than that of the sintering 208 (e.g., based on a lower melting point of a selected filler material) and/or for a different duration (e.g., <60 seconds). In some embodiments, the infiltration 212 is such that the filler materials completely permeate a thickness of the porous scaffold 210, for example, to form a uniformly dense layer 214 extending from an interface with the porous support layer 202 to an exposed upper surface of the layer 214. Alternatively, in some embodiments, the infiltration 212 can be such that the filler materials permeate to a depth of at least 0.5 μm from the exposed upper surface of the layer 214.

### Electrode Layers Formed From Porous Support Layers

Since the support layer 202 is porous, in some embodiments, the support layer 202 can be used as a host for anode or cathode materials to serve as an electrode in a full cell assembly. in addition to supporting the composite SSE during and after fabrication thereof. For example, FIG. 2B illustrates a process 220 for fabrication of a layer assembly with the porous support layer forming an anode. In the illustrated example, an SSE layer 222 has been previously formed on the porous support layer 202. In some embodiments, the SSE layer 222 can be a composite SSE, for example, formed by the process 200 of FIG. 2A and/or incorporating multiple layers of different SSE materials (e.g., as shown in FIGS. 1B-1C). Alternatively, in some embodiments, the SSE layer 222 can be a single layer SSE, for example, formed directly on a surface of the support layer 202 via sintering (e.g., similar to formation of layer 126c in FIG. 1B) or separately formed and provided on the support layer surface (e.g., via any conventional technique, such as printing, spraying, tape transfer, etc.). At 224, a cathode 230 can be provided over (e.g., via lamination) the SSE layer 222, such that the SSE layer 222 is disposed between the cathode 230 and the porous support layer 202.

In the illustrated example, the cathode 230 can be formed by a cathode support substrate 226 infiltrated with cathode active materials 228. In some embodiments, the cathode support substrate 226 can be a porous substrate formed of a conductive material. For example, the cathode support substrate 226 can be formed of porous carbon, such as a matrix of carbon black particles (e.g., 5-10 wt %). In some embodiments, the cathode active materials 228 can have a composition comprising lithium and another metal. Alternatively, in some embodiments, the cathode can be and/or include a liquid electrolyte, for example, as disclosed in Cheng et al., “Ionic liquid-containing cathodes empowering ceramic solid electrolytes,” iScience, March 2022, 25(3), 103896, which is incorporated by reference herein. Other configurations and compositions for the cathode 230 are also possible according to one or more contemplated embodiments.

In the illustrated example, the anode 234 can be formed by infiltrating the porous support layer 202 with Li (e.g., when used in a lithium ion battery) at 232. The integrated layer assembly 236 can then be used as a battery, for example, after appropriate packaging. In some embodiments, the Li can be infiltrated at 232 in a limited manner, for example, to confine infiltration to the porous support layer 202. Alternatively or additionally, the Li can be infiltrated into the entire layer assembly 236. In such cases, the cathode 230 can be pre-delithiated.

FIG. 2C illustrates another process 240 for fabrication of a layer assembly with the porous support layer forming an anode. In the illustrated example, a cathode 230 is initially provided. As discussed above, the cathode 230 can be formed by a porous cathode support layer 226 infiltrated with cathode active materials 228. At 242, one or more precursors 244 for an SSE layer can be provided on the cathode 230 via any known deposition technique (e.g., spray coating, blade coating, printing, vapor deposition, etc.). At 246, the precursors 244 can be subjected to sintering to convert the precursors 244 into an SSE layer 248. In some embodiments, the precursor layer 244, sintering 246, and SSE layer 248 can be similar to precursor layer 206, sintering 208, and porous scaffold 210, respectively of FIG. 2A. In such embodiments, the porous scaffold can be further infiltrated with fillers to yield a substantially nonporous SSE layer 248, for example, in a manner similar to that described above with respect to FIG. 2A. Alternatively, in some embodiments, the SSE precursors can be directly formed into a substantially nonporous layer, for example, by application of an appropriate duration heating wave. For example, the heating wave of sintering 246 can be at a temperature in a range of 1200-3000 K for a duration less than or equal to 60 s (e.g., 10-20 s).

In the illustrated example of FIG. 2C, a porous support layer 202 can then be provided on the SSE layer 248, for example, via lamination. In some embodiments, the porous support layer 202 can be formed of conductive carbon or metal, for example, as described above with respect to FIGS. 2A-2B. After provision of the porous support layer 202, the anode 234 can be formed in a manner similar to that described above with respect to FIG. 2B, for example, by Li infiltration at 232 to yield a layer assembly with the SSE layer 248 disposed between the anode 234 and cathode 230.

FIG. 2D illustrates another process 260 for fabrication of a layer assembly with the porous support layer forming an anode. In the illustrated example, the cathode 230 and the SSE layer 248 can be formed in a manner similar to that described above with respect to FIG. 2C. At 262, a metal layer can be provided on the SSE 248 (e.g., via lamination, contact with a metal melt, vapor deposition, sputtering, etc.) to serve as the anode 264. In some embodiments, the metal layer can be solid Li. Alternatively, in some embodiments, the metal layer can be formed as a porous layer (e.g., Cu foam, Ni foam, Ti mesh, etc.), for example, as a host for infiltration of Li.

Although the above described examples focus on the conversion of the porous support layer into an anode electrode, embodiments of the disclosed subject matter are not limited thereto. Indeed, in some embodiments, the porous support layer can be converted to a cathode instead by appropriate selection of compositions of the infiltrating material composition (e.g., cathode active materials) and/or the support layer (e.g., carbon black or metal foam/mesh).

### Fabrication Methods Using Porous Support Layers

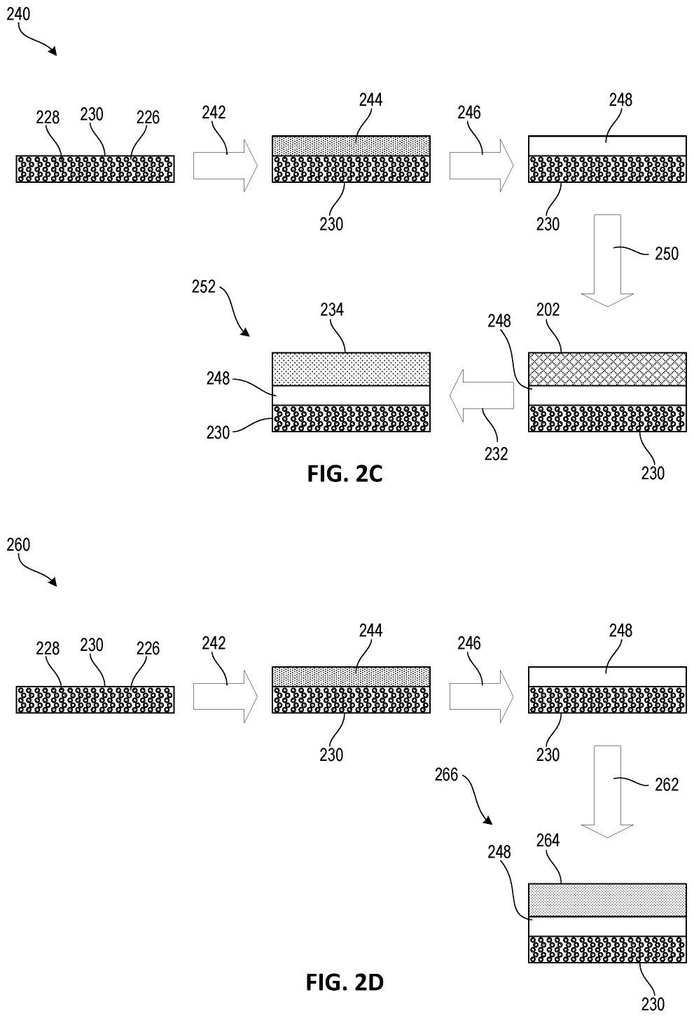

FIG. 3 illustrates a method 300 for fabricating a layer assembly with composite SSE and a porous support layer. The method 300 can initiate at terminal block 302 and proceed to process block 304, where a porous support layer can be provided. For example, the porous support layer can comprise a porous matrix of conductive material (e.g., carbon-based material such as carbon nanotubes, metal foam, metal mesh, etc.). The method 300 can proceed to process block 306, where one or more precursors for forming an SSE are provided on a first surface of the porous support layer. The provision of process block 306 can employ any known deposition technique, such as but not limited to spray coating, printing, blade coating, and vapor deposition. Alternatively or additionally, the precursors can be provided in powder form, and the provision of process block 306 can include, for example, ball-milling and/or calcination. In some embodiments, the precursors are of an ion-conducting oxide, for example, having a melting point greater than a first temperature (e.g., 1200 K).

The method 300 can proceed to process block 308, where the precursors (and the porous support layer) are subjected to one or more first high-temperature heating waves so as to convert the precursors into a sintered porous scaffold. In some embodiments, the first high-temperature heating wave(s) is performed at a peak temperature less than the first temperature and for a limited duration. For example, the duration of the first heating wave can be limited to 10 seconds or less (e.g., ˜5 s), and a temperature of the first heating wave can be ˜1100 K. The first heating wave can be performed via Joule heating or any other heating modality capable of generating the high temperatures of limited duration.

The method 300 can proceed to process block 310, where one or more filler materials (or precursors thereof) are provided on the porous scaffold. In some embodiments, the filler materials can be disposed on an exposed surface on a side of the porous scaffold opposite the porous support layer. provision of process block 306 can employ any known deposition technique, such as but not limited to spray coating, printing, blade coating, and vapor deposition. Alternatively or additionally, the filler materials can be provided in powder form, and the provision of process block 310 can include, for example, ball-milling and/or calcination. In some embodiments, the filler materials are a glassy material, for example, having a melting point less than the first temperature (e.g., in a range of 500-1100 K).

The method 300 can proceed to process block 312, where the one or more filler materials (and the porous scaffold and the porous support layer) are subjected to one or more second high-temperature heating waves so as to melt the filler materials and allow the melt to infiltrate the porous scaffold, thereby forming a substantially non-porous SSE layer. In some embodiments, the infiltration is sufficient to completely fill the porous scaffold. Alternatively, in some embodiments, the filler material penetrates to a depth of a least 0.5 μm from the exposed surface of the porous scaffold. In some embodiments, the second high-temperature heating wave(s) is performed at a peak temperature greater than a melting point of the filler material and for a limited duration. For example, the duration of the second heating wave can be limited to 10 second or less (e.g., ˜5 s), and a temperature of the first heating wave can be ˜1100 K. The first heating wave can be performed via Joule heating or any other heating modality capable of generating the high temperatures of limited duration.

The method 300 can proceed to decision block 314, where it is determined if additional SSE layers are desired, for example to provide additional layers that alter an electrochemical window of the composite SSE and/or protect an SSE layer from degradation via contact with one of the electrodes. If additional layers are desired for the composite SSE, the method 300 can proceed from decision block 314 to process block 316, where additional precursors can be disposed on an exposed surface of a previously formed layer (e.g., on a side of the previously formed layer opposite the porous support layer). The provision of process block 316 can employ any known deposition technique, such as but not limited to spray coating, printing, blade coating, and vapor deposition. Alternatively or additionally, the precursors can be provided in powder form, and the provision of process block 316 can include, for example, ball-milling and/or calcination. In some embodiments, the precursors are of an ion-conducting oxide, for example, having a melting point greater than the first temperature.

The method 300 can then proceed to process block 318, where the precursors (and previously-formed SSE layers and the porous support layer) are subjected to one or more third high-temperature heating waves so as to convert the precursors into a sintered SSE layer. In some embodiments, the third high-temperature heating wave(s) is performed at a peak temperature greater than the first temperature and for a limited duration. For example, the duration of the third heating wave can be limited to 60 seconds or less (e.g., ˜10-20 s), and a temperature of the third heating wave can be in a range of 1200-3000 K. The third heating wave can be performed via Joule heating or any other heating modality capable of generating the high temperatures of limited duration. In some embodiments, the composition of the newly sintered SSE layer can be different than the previously formed SSE layers. After the third heating wave, the method 300 can return to decision block 314.

If no additional SSE layers are desired at decision block 314, the method 300 can proceed to process block 320, where at least a portion of the porous support layer is converted into a first electrode (e.g., one of the anode and cathode of a battery). In some embodiments, the conversion of process block 320 can include infiltrating the porous support layer with a Li metal to form an anode or infiltrating the porous support layer with cathode active materials to form a cathode. The method 300 can proceed to process block 322, where a second electrode (e.g., the other of the anode and cathode of the battery) is provided on a side of the composite SSE opposite from the porous support layer. In some embodiments, the provision of process block 322 can include disposing (e.g., via lamination) an electrode layer (e.g., a cathode support with cathode active materials for the cathode, or a Li metal layer or Li-infiltrated porous metal for the anode) on the composite SSE. Alternatively or additionally, in some embodiments, the anode and/or the cathode can be integrally formed on a respective surface of the SSE, for example, by sintering a layer directly on the SSE (e.g., as described in International Publication No. WO 2020/236767, published Nov. 26, 2020 and entitled “High temperature sintering systems and methods,” which is incorporated herein by reference).

Although illustrated separately, it is contemplated that various process blocks may occur simultaneously or iteratively. Furthermore, certain process blocks illustrated as occurring after others may indeed occur before. Although blocks 304-322 of method 300 have been described as being performed once, in some embodiments, multiple repetitions of a particular process block may be employed before proceeding to the next decision block or process block. In addition, although blocks 304-322 of method 300 have been separately illustrated and described, in some embodiments, process blocks may be combined and performed together (simultaneously or sequentially). Moreover, although FIG. 3 illustrates a particular order for blocks 304-322, embodiments of the disclosed subject matter are not limited thereto. Indeed, in certain embodiments, the blocks may occur in a different order than illustrated or simultaneously with other blocks. In some embodiments, method 300 may comprise only some of blocks 304-322 of FIG. 3B.

### High-Temperature Heating Wave

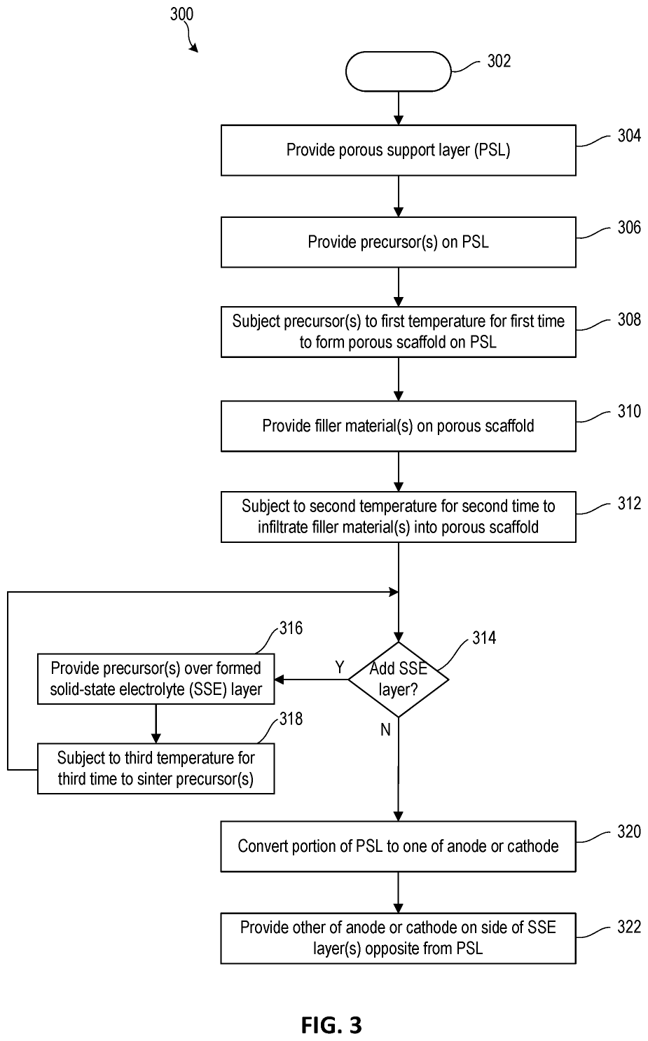

In any of the disclosed examples, a heating source (e.g., one or more Joule heating elements) can subject SSE precursors to a high-temperature heating wave for a short duration to form a sintered structure and/or can subject filler materials to a high-temperature heating wave for a short duration to melt the materials for infiltration into a porous SSE scaffold. For example, FIG. 4A shows an exemplary wave 400 for a high-temperature heating wave. In some embodiments, the heating wave 400 can provide a rapid transition to and/or from the high temperature T_{H}, for example, from/to a low temperature T_{L}, such as room temperature (e.g. 20-25° C.) or an elevated temperature (e.g., <500 K, such as 100-200° C.). For example, the heating wave 400 can include a short dwell period t₁ (e.g., ≤60 s) at or about sintering temperature T_{H} (e.g., at least 500 K).

In some embodiments, the dwell period t₁ can be less than or equal to 10 s (e.g., in a range of 3-10 s, such as ˜5 s) and/or the high temperature T_{H} can be less than or equal to 1200 K (e.g., ˜1100 K), for example, when the heating wave is used to form a porous scaffold and/or melt the filler materials. In some embodiments, the dwell period t₁ can be less than or equal 30 s (e.g., in a range of 10-20 s) and/or high temperature T_{H} can be at least 1200 K (e.g., 1200-3000 K), for example, when sintering to directly form a nonporous SSE layer from precursors. In some embodiments, the heating wave 400 can further include a rapid transition to and/or from the high temperature T_{H}, for example, from/to the low temperature _{TL}. For example, the heating wave 400 can include a rapid heating ramp R_{H} (e.g., ≥10³ K/s, such as 10⁴-10⁵ K/s, inclusive) and/or a rapid cooling ramp R_{C} (e.g., ≥10³ K/s, such as 10⁴-10⁶ K/s, inclusive).

In some embodiment, the high-temperature heating wave can be provided by Joule heating, microwave heating, laser heating, electron beam heating, spark discharge heating, or any other heating mechanism capable of providing the sintering temperature, heating rate, and/or cooling rate. For example, the systems and methods for providing the high-temperature heating wave can be similar to those disclosed in International Publication No. WO 2020/236767, published Nov. 26, 2020 and entitled “High temperature sintering systems and methods,” and International Publication No. WO 2022/204494, published Sep. 29, 2022, published Sep. 29, 2022 and entitled “High temperature sintering furnace systems and methods,” both of which are incorporated herein by reference. For example, a controller can control an electrical power source to apply time-limited current to the Joule heating element that causes the heating element to rapidly increase to the high temperature, dwell at the high temperature for a predetermined time period, and then rapidly cool from the high temperature.

In some embodiments, the high-temperature heating wave can be terminated by conveying the sintered structures out of a heating zone and/or by de-activating, de-energizing, or otherwise terminating operation of the heating elements. Alternatively or additionally, in some embodiments, cooling at the end of a heating wave can be achieved using one or more passive cooling features (e.g., heat sinks thermally coupled to the heating element and/or sintered structures, etc.), one or more active cooling features (e.g., fluid flow directed at the sintered structures and/or the heater, fluid flow through a heat sink thermally coupled thereto, etc.), or any combination thereof.

### Computer Implementation

FIG. 4B depicts a generalized example of a suitable computing environment 431 in which the described innovations may be implemented, such as but not limited to aspects of method 300 and/or a controller of a heating or sintering system (e.g., furnace). The computing environment 431 is not intended to suggest any limitation as to scope of use or functionality, as the innovations may be implemented in diverse general-purpose or special-purpose computing systems. For example, the computing environment 431 can be any of a variety of computing devices (e.g., desktop computer, laptop computer, server computer, tablet computer, etc.).

With reference to FIG. 4B, the computing environment 431 includes one or more processing units 435, 437 and memory 439, 441. In FIG. 4B, this basic configuration 451 is included within a dashed line. The processing units 435, 437 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 4B shows a central processing unit 435 as well as a graphics processing unit or co-processing unit 437. The tangible memory 439, 441 may be volatile memory (e.g., registers, cache, RAM), non-volatile memory (e.g., ROM, EEPROM, flash memory, etc.), or some combination of the two, accessible by the processing unit(s). The memory 439, 441 stores software 433 implementing one or more innovations described herein, in the form of computer-executable instructions suitable for execution by the processing unit(s).

A computing system may have additional features. For example, the computing environment 431 includes storage 461, one or more input devices 471, one or more output devices 481, and one or more communication connections 491. An interconnection mechanism (not shown) such as a bus, controller, or network interconnects the components of the computing environment 431. Typically, operating system software (not shown) provides an operating environment for other software executing in the computing environment 431, and coordinates activities of the components of the computing environment 431.

The tangible storage 461 may be removable or non-removable, and includes magnetic disks, magnetic tapes or cassettes, CD-ROMs, DVDs, or any other medium which can be used to store information in a non-transitory way, and which can be accessed within the computing environment 431. The storage 461 can store instructions for the software 433 implementing one or more innovations described herein.

The input device(s) 471 may be a touch input device such as a keyboard, mouse, pen, or trackball, a voice input device, a scanning device, or another device that provides input to the computing environment 431. The output device(s) 471 may be a display, printer, speaker, CD-writer, or another device that provides output from computing environment 431.

The communication connection(s) 491 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

### Porous Scaffold Infiltrated With Filler Materials

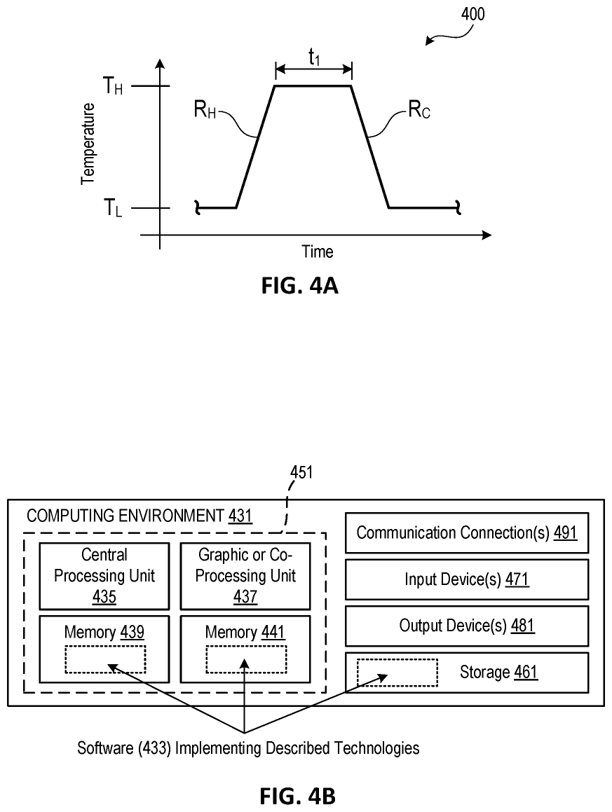

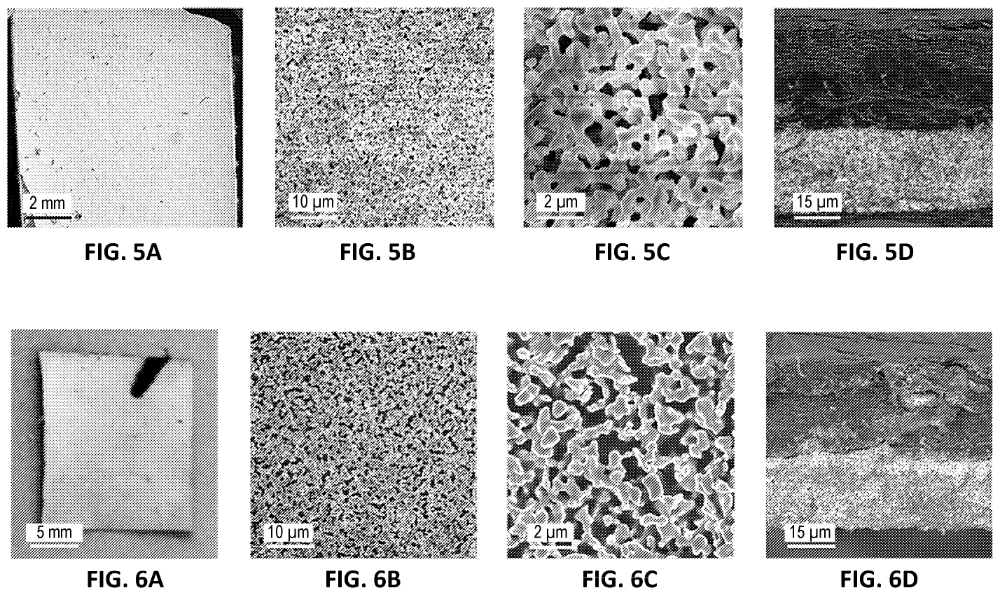

A carbon nanotube (CNT) support was used to form an Li₂La₃Zr₂TaO₁₂ (LLZTO) porous scaffold, after which the scaffold was infiltrated with melted Li₃BO₃ (LBO) glass to form a dense, composite SSE. In particular, a two-step fabrication process was used. First, a porous LLZTO film was formed on the CNT support by sintering LLZTO precursors at 1100 K for only 5 seconds. This short-duration heating wave formed the LLZTO porous scaffold on the CNT support, but with a substantially crack-free morphology, as shown in FIG. 5A. The magnified images of FIGS. 5B-5C further show that the LLZTO scaffold has a continuous, porous microstructure due in part to the accurate control of the sintering time and temperature. Moreover, as shown in FIG. 5D, the LLZTO porous scaffold has a seamless interface with the CNT support. In the second step of the fabrication process, the LBO glass is disposed on the porous LLZTO film and subjected to another short-duration heating wave, in particular, 1100 K for only 5 seconds. This second short-duration heating wave is sufficient to melt the LBO, thereby allowing it to penetrate into and fill the pores of the LLZTO scaffold to achieve a dense composite SSE layer, as shown in FIG. 6A. The CNT-supported LBO/LLZTO composite SSE film exhibits a highly-dense structure, as shown in FIGS. 6B-6C. As shown in FIG. 6D, a tight interface between the CNT support and the dense composite SSE layer was maintained.

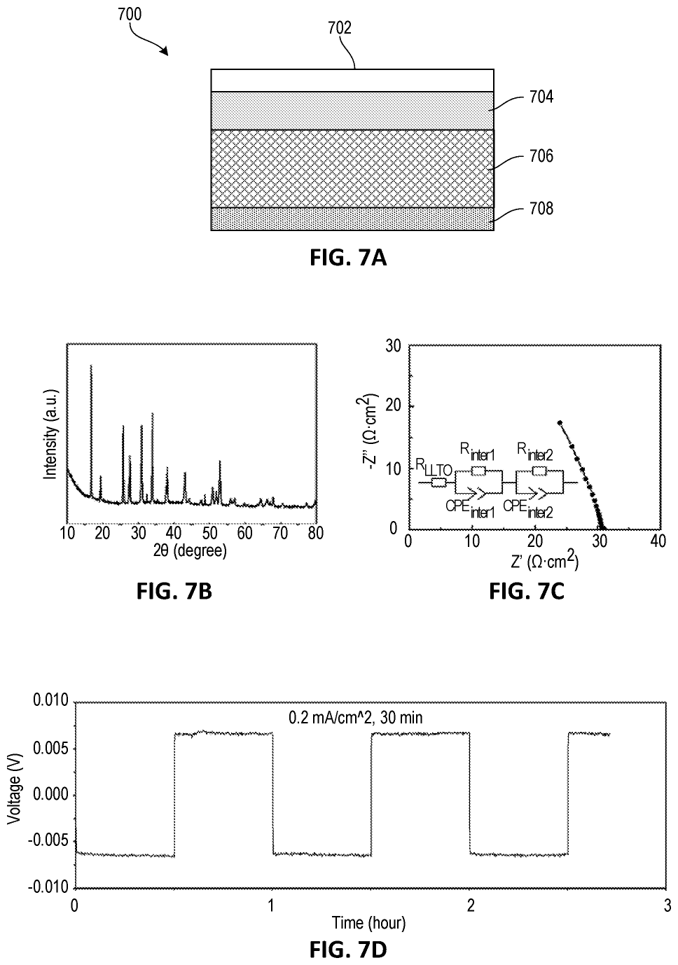

As shown in FIG. 7B, the composite SSE on CNT support shows the desired phase, in agreement with the standard diffraction pattern of LLZTO. To test electrochemical properties, the asymmetric test cell 700 of FIG. 7A was fabricated. In particular, the test cell 700 included an electrode 702 formed of Li and an adjacent composite SSE layer 704 (LLZTO/LBO) supported on a porous support layer 706 (CNT). Li melt 708 was also provided at an end of the porous support layer 706 opposite the Li electrode 702. Using this asymmetric test cell 700, the conductivity of the composite SSE and its galvanostatic cycling performance was evaluated. As shown in FIGS. 7C-7D, the composite SSE delivers a high Li-ion conductivity of 7×10⁻⁵ S/cm and a stable charging/discharging curve with a low overpotential of 7 mV at 0.2 mA/cm².

### Multi-Layer Structures

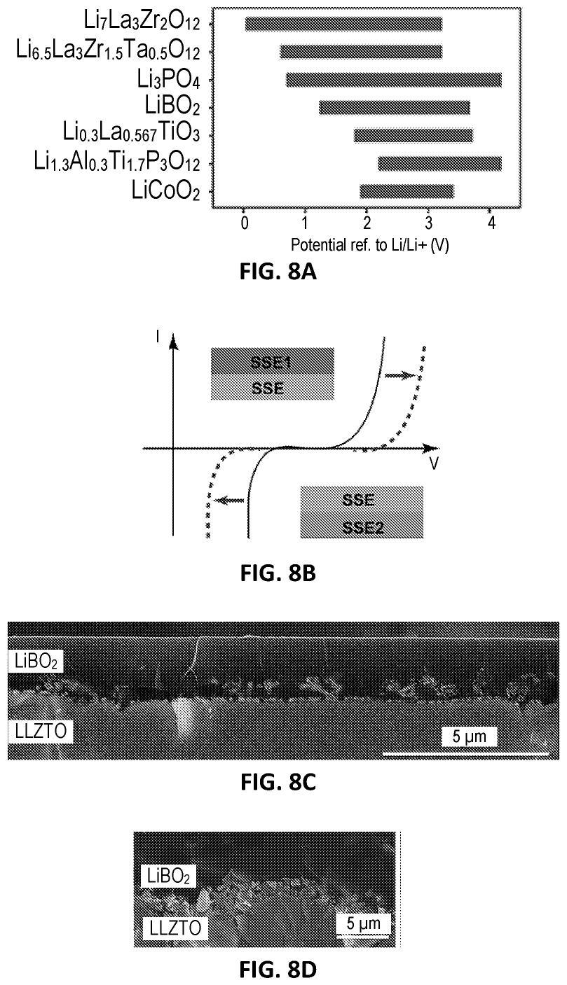

Multilayer structures were formed to provide composite SSEs with widened electrochemical voltage windows and that can remain stable against electrode materials (e.g., cathode and Li metal anode). The multilayer structures were achieved by using continuous ink printing followed by application of a high-temperature wave (e.g., a temperature of 1200-3000 K for a duration≤30 s). Computations indicate that garnet LLZTO and Li₃ₓLa_{2/3-x}TiO₃ (LLTO) have either relatively low oxidation or high reduction potential, resulting in limited electro-chemical stability with the cathode or Li metal anode. To identify SSE layer additions that could be used to improve performance, electrochemical windows were calculated for several other materials, including NASICON-type Li_{1.3}Al_{0.3}Ti_{1.7}P₃O₁₂ (LATP), Li₂La₃Zr₂O₁₂ (LLZO), LiCoO₂, LiBO₂, and Li₃PO₄. The results of the calculations are summarized in FIG. 8A. These materials can have better stability at high or low voltages when incorporated into a multilayer structure design, as shown in FIG. 8B.

In a fabricated example, a multilayer composite SSE was formed of LiBO₂ and LLZTO. In particular, LiBO₂ precursor powder was put on an LLZTO membrane and sintered by a short duration heating wave using a Joule heating element. The LiBO₂/LLZTO SSE remained ˜0.5 mm from the Joule heating element throughout the heating wave, thereby decreasing the thermal loss during sintering and offering a shortened sintering time. Once the sintering temperature reached up to ˜1073 K, the LiBO₂ powder melted to liquid and spread out on the LLZTO surface, forming a compact and uniform interface with LLZTO, as shown in FIG. 8C. Such an interface can be conducive to decreasing the interface resistance. Even with a thickness of ˜3 μm, the sintered LiBO₂ thin film retained a clear interface with LLZTO, as shown in FIG. 8D. No interlayer elemental co-diffusion was observed, suggesting the elemental diffusion was effectively inhibited by heating wave technique. In conventional sintering, it can be a challenge for multilayer garnet SSEs with NASICONs (e.g., NASICON and garnet) or glass (e.g., glass and garnet) to retain high ion conductivity, as the extended duration sintering can lead to Li loss that reduces ion conductivity. In contrast, the use of a short-duration heating wave to sinter each SSE layer can avoid, or at least reduce, Li loss, thereby maintaining ion conductivity of the resulting multi-layer composite SSE. Indeed, the multilayer SSE formed by LiBO₂ and LLZTO exhibited an ion conductivity of 3 mS/cm, which is among the highest values reported for garnet bulk.

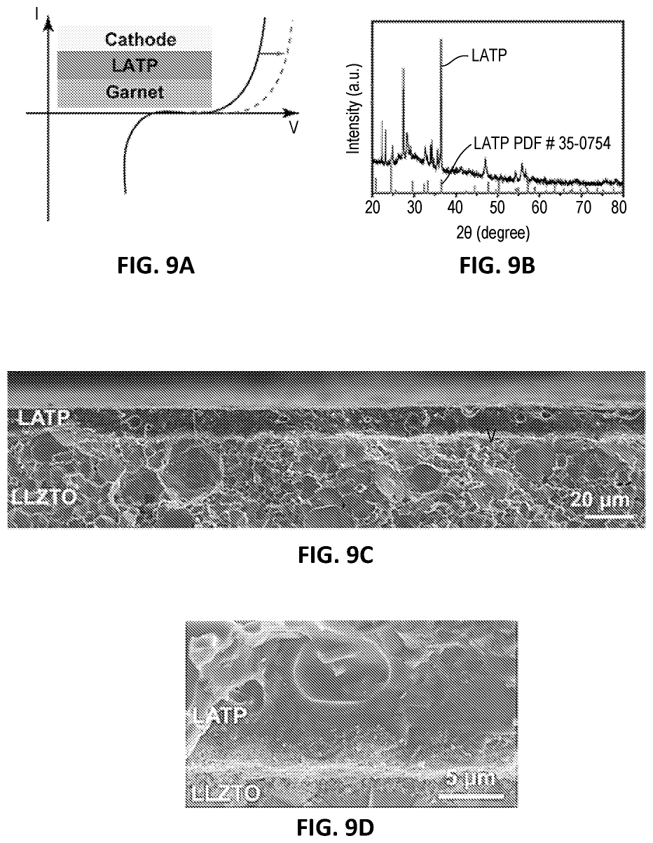

In another example, garnet has a high ion conductivity of ˜1 mS/cm and excellent stability with Li metal, but has a relatively oxidation potential of ˜3 V that limits its ability to be paired with higher voltage cathode materials. Moreover, due to the chemical instability with cathode material at high sintering temperature (e.g., >773 K), garnet could not be co-sintered with certain cathodes, such as LiCoO₂, as it can lead to inferior interfacial contact and/or increase interfacial resistance. To widen the electrochemical window of garnet SSEs, NASICON can be used as a thin buffer layer between the garnet and cathode materials, as shown in FIG. 9A. For example, LATP features a high ion conductivity of ˜1 mS/cm and is calculated to have a high anodic potential of 4.31 V. LATP can thus be used to widen the oxidation potential of garnet for pairing with an LiCoO₂ cathode.

As noted above, conventional sintering can suffer challenges due to Li loss and elemental interlayer co-diffusion, leading to decreased ion conductivity and impaired battery performance. As such, it can be challenging to fabricate a multilayer SSE with LATP and LLZTO using conventional techniques. In contrast, a solution-based technique together with the limited-duration, high-temperature heating wave was employed to successfully sinter an LATP thin film on an LLZTO pellet with a tight interface, as shown in FIG. 6C. In particular, LATP precursor ink was directly printed on the LLZTO pellet and subsequently sintered for ˜5 s. Once the sintering temperature reached ˜1473 K, the LATP precursors reacted and densified within ˜5 s, forming a continuous and dense coating layer on the LLZTO surface. Due to the short sintering time, the Li loss is effectively inhibited, generating a LATP thin film with pure NASICON-type structure at a desired high ionic conductivity, as shown in FIG. 9B. As shown in FIG. 9C, the thickness of the LATP coating layer was ˜10 μm, which is much thinner than the LLZTO pellet (˜400 μm) and thus conducive to achieving a high gravimetric energy density. As suggested by FIGS. 9D-9E, a tight interface was maintained between the layers (exhibiting decreased interface resistance), and no interlayer co-diffusion was observed. This multilayer SSE formed of LATP and LLZTO can allow LLZTO to be co-sintered with LiCoO₂ cathode for full cell assembly.

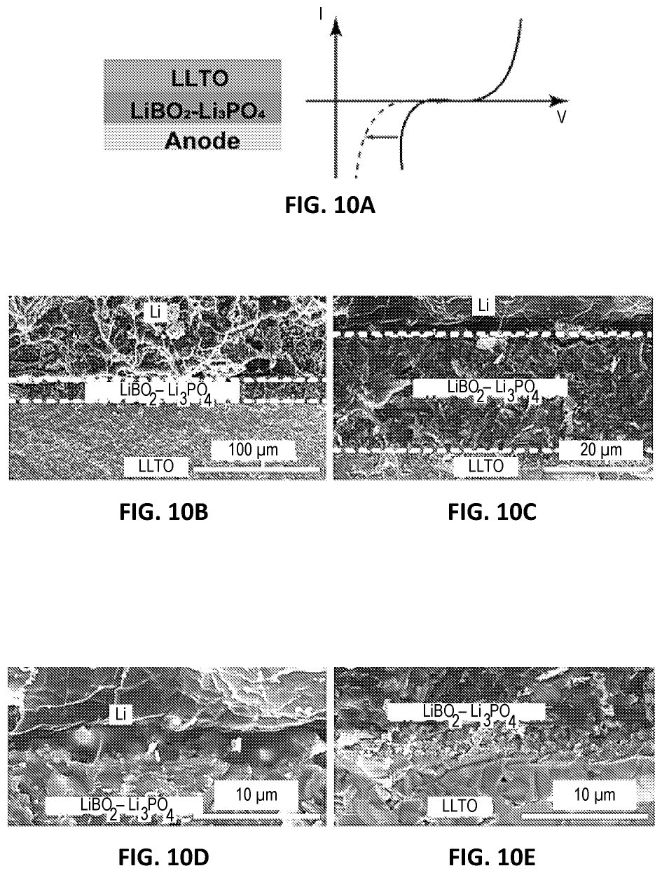

In another example, a multilayer SSE of LiBO₂—Li₃PO₄ and perovskite-type LLTO was fabricated to decrease the reduction potential of LLTO to 0.69 V. effectively improving the chemical stability of LLTO with the Li metal anode. LLTO is attractive for solid-state battery applications in view of its high ion conductivity, but it tends to decompose when in contact with Li metal. Glass SSEs, in particular LiBO₂—Li₃PO₄, were selected to provide a protection layer as part of the SSE, as shown in FIG. 10A. Since the glass SSE exhibits excellent chemical stability to Li metal, it can insulate the LLTO from the Li metal anode. To protect the LLTO, the coating layer needs to be very dense without any pinholes, as Ti⁴⁺ can otherwise reduce to Ti³⁺ once it contacts with the Li metal. Such layers are difficult to achieve in conventional sintering due to elemental co-diffusion and cracking of ceramics. In contrast, the use of a limited-duration high-temperature heating wave can effectively form the multilayer SSE with this pinhole-free protective layer.

In the fabricated example, the LiBO₂—Li₃PO₄ layer was melted at a high sintering temperature to form a dense structure without any cracks or pinholes, as shown in FIGS. 10B-10E. After immersing into a molten Li-Sn alloy at 423 K, the molten Li metal well wetted the LiBO₂—Li₃PO₄ surface without any reaction and forms an integrated and uniform interface, as shown in FIG. 10D, further enhancing the high density of the LiBO₂—Li₃PO₄ layer. The LiBO₂—Li₃PO₄ layer thus prevented direct contact between the LLTO and Li layers, thereby inhibiting the LLTO from being reduced by the molten Li metal.

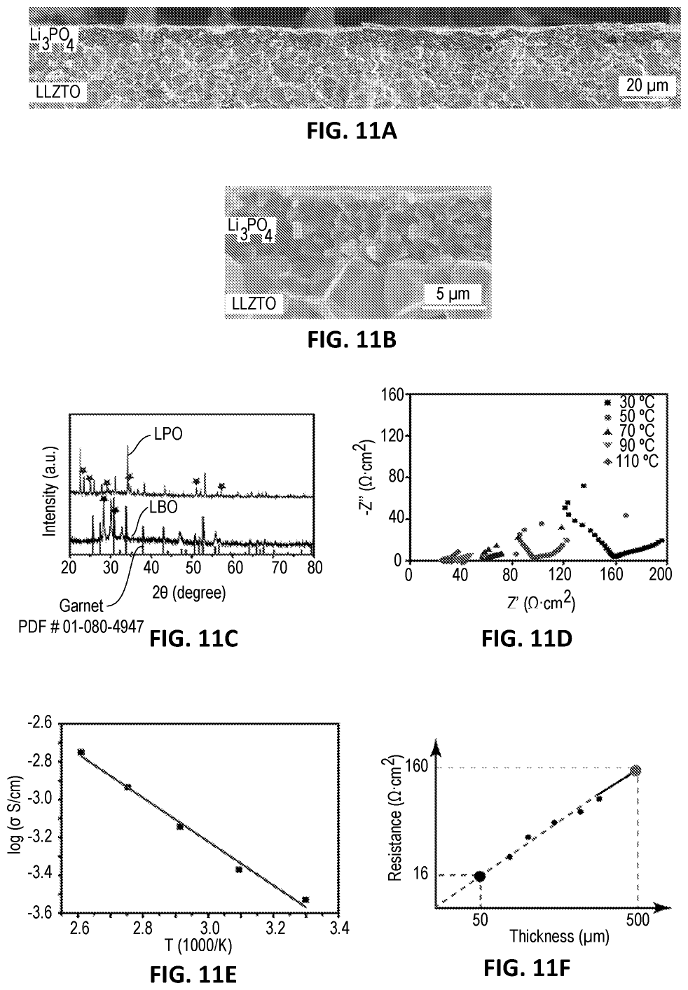

In another example, a composite SSE was formed by layers of Li₃PO₄ (LPO) and LLZTO. Using a sintering temperature of ˜1773 K for a short duration (e.g., 3 s), a glass Li₃PO₄ protection layer was melted onto an LLZTO pellet, as shown in FIG. 11A. The resulting Li₃PO₄ layer had a thickness of ˜5 μm. The high sintering temperature can enable the Li₃PO₄ thin film to adopt a crystal structure with merged fine grains, which can help to increase the ion conductivity. As shown in FIG. 11B, a compact, uniform, and clear interlayer interface was generated, demonstrating that the element interlayer co-diffusion was well inhibited. As shown in FIG. 11C, the Li₃PO₄ exhibited a pure phase structure, suggesting the effective inhibition of Li loss during sintering as a result of the short sintering time.

FIG. 11C also shows similar results obtained for a glass LiBO₂ (LBO) layer on LLZTO subjected to a similar fabrication process. To further evaluate the Li loss, the ion conductivity of the multilayer SSE LiBO₂-LLZTO was tested and found to be 0.3 mS/cm with the activation energy of ˜0.23 eV, as shown in FIGS. 11D-11E. The interface resistance of the bilayer LiBO₂-LLZTO was estimated to be ˜24 Ω·cm² using the highest reported ion conductivity of LiBO₂ (e.g., 10⁻⁵-10⁻⁸ S/cm). The actual interface resistance should be much lower than 24 Ω·cm² due to the thin LiBO₂ coating layer, as suggested by the relationship in FIG. 11F.

### ADDITIONAL EXAMPLES OF THE DISCLOSED TECHNOLOGY

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. A method comprising:
   (a) providing one or more precursors on a first surface of a porous support layer;
   (b) subjecting the porous support layer with one or more precursors to a first temperature for a first time so as to sinter the one or more precursors to form a porous scaffold. the first temperature being less than or equal to about 1200 K, the first time being less than or equal to about 60 seconds, the porous scaffold comprising an ion-conducting oxide;
   (c) providing one or more filler materials on a second surface of the porous scaffold, the one or more filler materials having a melting point in a range of 500-1100 K, inclusive; and
   (d) subjecting the porous scaffold with the one or more filler materials to a second temperature for a second time so as to melt the one or more filler materials to form a non-porous composite solid-state electrolyte layer with the one or more filler materials infiltrating the porous scaffold, the second temperature being less than or equal to about 1200 K, the second time being less than or equal to about 60 seconds.
Clause 2. The method of any clause or example herein, in particular, Clause 1, wherein:
   the second temperature is about the same as or less than the first temperature;
   the first temperature is about 1100 K;
   the second temperature is about 1100 K; or
   any combination of the above.
Clause 3. The method of any clause or example herein, in particular, any one of Clauses 1-2, wherein:
   the second time is about the same as or less than the first time;
   the first time is about 5 seconds;
   the second time is about 5 seconds; or
   any combination of the above.
Clause 4. The method of any clause or example herein, in particular, any one of Clauses 1-3, wherein the composite solid-state electrolyte layer conducts alkali metal ions, alkali earth metal ions, anions, or any combination of the foregoing.
Clause 5. The method of any clause or example herein, in particular, any one of Clauses 1-4, wherein the composite solid-state electrolyte layer conducts lithium ions, sodium ions, potassium ions, magnesium ions, calcium ions, oxygen ions, or any combination of the foregoing.
Clause 6. The method of any clause or example herein, in particular, any one of Clauses 1-5, wherein the porous support layer comprises carbon or a metal.
Clause 7. The method of any clause or example herein, in particular, any one of Clauses 1-6, wherein the porous support layer comprises a matrix of carbon nanofibers.
Clause 8. The method of any clause or example herein, in particular, any one of Clauses 1-6, wherein the porous support layer comprises a metal mesh.
Clause 9. The method of any clause or example herein, in particular, any one of Clauses 1-8, wherein the melting of (d) is such that the one or more filler materials infiltrate into the porous scaffold to a depth from the second surface of the porous scaffold greater than or equal to 0.5 μm.
Clause 10. The method of any clause or example herein, in particular, any one of Clauses 1-9, wherein the one or more filler materials comprises a glassy ion-conducting material.
Clause 11. The method of any clause or example herein, in particular, any one of Clauses 1-10, wherein the one or more filler materials comprises Li₃BO₃, LiCl, LiBr, LiI, LiF, Li₃N, LiBH₄, LiBF₄, or any combination of the foregoing.
Clause 12. The method of any clause or example herein, in particular, any one of Clauses 1-11, wherein:
   the ion-conducting oxide of the porous scaffold comprises a compound having a formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F},
   where 4<A<8.5, 1.5<B<4, 0≤C≤2, 0≤D≤2, 0≤E<2, and 10<F<13,
   M′ is a first one selected from Al, Mo, W, Nb, Sb, Ca, Ba, Sr, Ce, Hf, Rb, or Ta, and
   M″ is a second one selected from Al, Mo, W, Nb, Sb, Ca, Ba, Sr, Ce, Hf, Rb, or Ta.
Clause 13. The method of any clause or example herein, in particular, any one of Clauses 1-11, wherein:
   the ion-conducting oxide of the porous scaffold comprises a compound having a formula of Li_{A}La_{B}Zr_{C}Al_{D}M′″_{E}O_{F},
   where 5<A<7.7, 2<B<4, 0<C≤2.5, 0≤D<2, 0≤E<2, and 10<F<13, and
   M″ is Nb, Ta, V, W, Mo, or Sb.
Clause 14. The method of any clause or example herein, in particular, any one of Clauses 1-11, wherein the ion-conducting oxide of the porous scaffold comprises perovskite-type Li_{0.33}La_{0.57}TiO₃, NASICON-type LiTi_{1.3}Al_{0.3}Ti_{1.7}(PO₄)₃, NASICON-type LiTi₂(PO₄)₃, NASICON-type Li₁₊ₓAlₓGe₂₋ₓ(PO₄)₃, garnet-type Li₂La₃Zr₂O₁₂ (LLZO), tantalum-doped Li₂La₃Zr₂TaO₁₂ (LLTZO), LISICON-type Li₁₄Zn(GeO₄)₄, or any combination of the foregoing, where x represents a number.
Clause 15. The method of any clause or example herein, in particular, any one of Clauses 1-11, wherein the ion-conducting oxide is tantalum-doped Li₂La₃Zr₂TaO₁₂ (LLTZO), and the one or more filler materials is Li₃BO₃.
Clause 16. The method of any clause or example herein, in particular, any one of Clauses 1-15, further comprising, after (d), forming one or more additional solid-state electrolyte layers on the composite solid-state electrolyte layer by sintering one or more additional precursors at a third temperature for a third time, the third time being less than or equal to about 60 seconds.
Clause 17. The method of any clause or example herein, in particular, Clause 16, wherein the one or more additional solid-state electrolyte layers have a material composition different from that of the composite solid-state electrolyte layer.
Clause 18. The method of any clause or example herein, in particular, any one of Clauses 16-17, wherein:
   the third temperature is greater than or equal to the first temperature;
   the third time is greater than or equal to the first time;
   the third temperature is in a range of 1000-1500 K, inclusive;
   the third time is in a range of 3-10 seconds, inclusive; or
   any combination of the above.
Clause 19. The method of any clause or example herein, in particular, any one of Clauses 1-18, further comprising:
   (e) forming one of a cathode and an anode of an electrochemical energy device over a side of the composite solid-state electrolyte layer opposite from the porous support layer; and
   (f) forming at least a portion of the porous support layer as the other of the cathode and the anode.
Clause 20. The method of any clause or example herein, in particular, Clause 19, wherein the electrochemical energy device is a battery or fuel cell.
Clause 21. The method of any clause or example herein, in particular, any one of Clauses 19-20, wherein the forming of (f) comprises infiltrating the at least a portion of the porous support layer with lithium to form the anode.
Clause 22. The method of any clause or example herein, in particular, Clauses 21, wherein a depth of the infiltrating of the lithium into the porous support layer is at least 0.5 μm.
Clause 23. The method of any clause or example herein, in particular, any one of Clauses 19-22, wherein (f) is performed after (d), after (e), or after both (d) and (e).
Clause 24. The method of any clause or example herein, in particular, any one of Clauses 19-20, wherein the forming of (f) comprises infiltrating the at least a portion of the porous support layer with one or more cathode active materials to form the cathode.
Clause 25. The method of any clause or example herein, in particular, Clause 24, wherein the one or more cathode active materials has a composition comprising lithium and another metal element.
Clause 26. The method of any clause or example herein, in particular, any one of Clauses 24-25, wherein the infiltrating with the one or more cathode active materials comprises disposing one or more cathode active materials with a liquid electrolyte on the porous support layer.
Clause 27. The method of any clause or example herein, in particular, any one of Clauses 24-26, wherein a depth of the infiltrating of the one or more cathode active materials into the porous support layer is at least 0.5 μm.
Clause 28. The method of any clause or example herein, in particular, any one of Clauses 24-27, wherein (f) is performed prior to (e), prior to (a), or prior to both (a) and (e).
Clause 29. The method of any clause or example herein, in particular, any one of Clauses 24-28, wherein the forming of (e) comprises providing a metal film over the composite solid-state electrolyte layer to form the anode.
Clause 30. The method of any clause or example herein, in particular, Clause 29, wherein the metal film is a lithium metal layer or a copper metal layer as current collector.
Clause 31. The method of any clause or example herein, in particular, any one of Clauses 24-28, wherein the forming of (e) comprises:
   providing another porous layer over the composite solid-state electrolyte layer; and
   infiltrating the another porous layer with lithium to form the anode.
Clause 32. The method of any clause or example herein, in particular, Clause 31, wherein the another porous layer comprises carbon.
Clause 33. The method of any clause or example herein, in particular, any one of Clauses 1-32, wherein:
   the subjecting of (b) comprises heating to the first temperature at a first heating rate in a range of about 10³ to about 10⁵ K/s, inclusive;
   the subjecting of (d) comprises heating to the second temperature at a second heating rate in a range of about 10³ to about 10⁵ K/s, inclusive;
   the subjecting of (b) comprises cooling from the first temperature at a first cooling rate in a range of about 10³ to about 10⁵ K/s, inclusive;
   the subjecting of (d) comprises cooling from the second temperature at a second cooling rate in a range of about 10³ to about 10⁵ K/s, inclusive; or
   any combination of the foregoing.
Clause 34. An electrochemical energy device comprising:
   a porous support layer; and
   a non-porous, composite solid-state electrolyte layer disposed on the porous support layer, the composite solid-state electrolyte layer comprising a porous scaffold and one or more filler materials infiltrating the porous scaffold, the porous scaffold comprising an ion-conducting oxide, the one or more filler materials having a melting point in a range of 500-1100 K, inclusive,
   wherein at least a portion of the porous support layer is infiltrated with one or more materials to form an electrode of the electrochemical energy device.
Clause 35. The electrochemical energy device of any clause or example herein, in particular, Clause 34, wherein the electrochemical energy device is a battery or fuel cell.
Clause 36. The electrochemical energy device of any clause or example herein, in particular, any one of Clauses 34-35, wherein the at least a portion of the porous support layer is infiltrated with lithium to form an anode of the electrochemical energy device.
Clause 37. The electrochemical energy device of any clause or example herein, in particular, Clause 36, wherein the lithium is infiltrated to a depth of at least 0.5 μm within the porous support layer.
Clause 38. The electrochemical energy device of any clause or example herein, in particular, any one of Clauses 36-37, further comprising a cathode of the electrochemical energy device disposed over a side of the composite solid-state electrolyte layer opposite from the porous support layer.
Clause 39. The electrochemical energy device of any clause or example herein, in particular, any one of Clauses 34-35, wherein the at least a portion of the porous support layer is infiltrated with one or more cathode active materials to form a cathode of the electrochemical energy device.
Clause 40. The electrochemical energy device of any clause or example herein, in particular, Clause 39, wherein the one or more cathode active materials has a composition comprising a metal and lithium.
Clause 41. The electrochemical energy device of any clause or example herein, in particular, any one of Clause 39, wherein the cathode comprises one or more cathode active materials with a liquid electrolyte.
Clause 42. The electrochemical energy device of any clause or example herein, in particular, any one of Clauses 40-41, wherein the one or more cathode active materials is infiltrated to a depth of at least 0.5 μm within the porous support layer.
Clause 43. The electrochemical energy device of any clause or example herein, in particular, any one of Clauses 39-42, further comprising an anode of the electrochemical energy device disposed over a side of the composite solid-state electrolyte layer opposite from the porous support layer.
Clause 44. The electrochemical energy device of any clause or example herein, in particular, Clause 43, wherein the anode comprises a metal film.
Clause 45. The electrochemical energy device of any clause or example herein, in particular, Clause 44, wherein the metal film is a lithium metal layer or a copper metal layer as current collector.
Clause 46. The electrochemical energy device of any clause or example herein, in particular, any one of Clauses 34-45, wherein the composite solid-state electrolyte layer conducts alkali metal ions, alkali earth metal ions, anions, or any combination of the foregoing.
Clause 47. The electrochemical energy device of any clause or example herein, in particular, any one of Clauses 34-46, wherein the composite solid-state electrolyte layer conducts lithium ions, sodium ions, potassium ions, magnesium ions, calcium ions, oxygen ions, or any combination of the foregoing.
Clause 48. The electrochemical energy device of any clause or example herein, in particular, any one of Clauses 34-47, wherein the porous support layer comprises carbon or a metal.
Clause 49. The electrochemical energy device of any clause or example herein, in particular, any one of Clauses 34-48, wherein the porous support layer comprises a matrix of carbon nanofibers.
Clause 50. The electrochemical energy device of any clause or example herein, in particular, any one of Clauses 34-48, wherein the porous support layer comprises a metal mesh.
Clause 51. The electrochemical energy device of any clause or example herein, in particular, any one of Clauses 34-50, wherein the one or more filler materials comprises a glassy ion-conducting material.
Clause 52. The electrochemical energy device of any clause or example herein, in particular, any one of Clauses 34-51, wherein the one or more filler materials comprises Li₃BO₃, LiCl, LiBr, LiI, LiF, Li₃N, LiBH₄, LiBF₄, or any combination of the foregoing.
Clause 53. The electrochemical energy device of any clause or example herein, in particular, any one of Clauses 34-52, wherein:
   the ion-conducting oxide of the porous scaffold comprises a compound having a formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F},
   where 4<A<8.5, 1.5<B<4, 0≤C≤2, 0≤D≤2, 0≤E<2, and 10<F<13,
   M′ is a first one selected from Al, Mo, W, Nb, Sb, Ca, Ba, Sr, Ce, Hf, Rb, or Ta, and
   M″ is a second one selected from Al, Mo, W, Nb, Sb, Ca, Ba, Sr, Ce, Hf, Rb, or Ta.
Clause 54. The electrochemical energy device of any clause or example herein, in particular, any one of Clauses 34-52, wherein:
   the ion-conducting oxide of the porous scaffold comprises a compound having a formula of Li_{A}La_{B}Zr_{C}Al_{D}M″′_{E}O_{F},
   where 5<A<7.7, 2<B<4, 0<C≤2.5, 0≤D<2, 0≤E<2, and 10<F<13, and
   M′″ is Nb, Ta, V, W, Mo, or Sb.
Clause 55. The electrochemical energy device of any clause or example herein, in particular, any one of Clauses 34-52, wherein the ion-conducting oxide of the porous scaffold comprises perovskite-type Li_{0.33}La_{0.57}TiO₃, NASICON-type Li_{1.3}Al_{0.3}Ti_{1.7}(PO₄)₃, NASICON-type LiTi₂(PO₄)₃, NASICON-type Li₁₊ₓAlₓGe₂₋ₓ(PO₄)₃, garnet-type Li₂La₃Zr₂O₁₂ (LLZO), tantalum-doped Li₂La₃Zr₂TaO₁₂ (LLTZO), LISICON-type Li₁₄Zn(GeO₄)₄, or any combination of the foregoing, where x represents a number.
Clause 56. The electrochemical energy device of any clause or example herein, in particular, any one of Clauses 34-52, wherein the ion-conducting oxide is tantalum-doped Li₂La₃Zr₂TaO₁₂ (LLTZO), and the one or more filler materials is Li₃BO₃.
Clause 57. The electrochemical energy device of any clause or example herein, in particular, any one of Clauses 34-56, further comprising at least one additional solid-state electrolyte layer, wherein the composite solid-state electrolyte layer is disposed between the at least one additional solid-state electrolyte layer and the porous support layer.
Clause 58. The electrochemical energy device of any clause or example herein, in particular, Clause 57, wherein the at least one additional solid-state electrolyte layer has a material composition different from that of the composite solid-state electrolyte layer.

### Conclusion

Any of the features illustrated or described herein, for example, with respect to FIGS. 1A-11F and Clauses 1-58, can be combined with any other feature illustrated or described herein, for example, with respect to FIGS. 1A-11F and Clauses 1-58 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
(a) providing one or more precursors on a first surface of a porous support layer;
(b) subjecting the porous support layer with one or more precursors to a first temperature for a first time so as to sinter the one or more precursors to form a porous scaffold, the first time being less than or equal to about 60 seconds, the porous scaffold comprising an ion-conducting oxide;
(c) providing one or more filler materials on a second surface of the porous scaffold, the one or more filler materials having a melting point in a range of 500-1100 K, inclusive; and
(d) subjecting the porous scaffold with the one or more filler materials to a second temperature for a second time so as to melt the one or more filler materials to form a non-porous composite solid-state electrolyte layer with the one or more filler materials infiltrating the porous scaffold, the second time being less than or equal to about 60 seconds.

2. The method of claim 1, wherein:
the first temperature is less than or equal to about 1200 K;
the second temperature is less than or equal to about 1200 K;
the second temperature is about the same as or less than the first temperature;
the first temperature is about 1100 K;
the second temperature is about 1100 K; or
any combination of the above.

3. (canceled)

4. The method of claim 1, wherein the composite solid-state electrolyte layer conducts alkali metal ions, alkali earth metal ions, anions, or any combination of the foregoing.

5. (canceled)

6. The method of claim 1, wherein the porous support layer comprises carbon or a metal.

7-10. (canceled)

11. The method of claim 1, wherein the one or more filler materials comprises Li₃BO₃, LiCl, LiBr, LiI, LiF, Li₃N, LiBH₄, LiBF₄, or any combination of the foregoing.

12-15. (canceled)

16. The method of claim 1, further comprising, after (d):
forming one or more additional solid-state electrolyte layers on the composite solid-state electrolyte layer by sintering one or more additional precursors at a third temperature for a third time, the third time being less than or equal to about 60 seconds.

17-18. (canceled)

19. The method of claim 1, further comprising:
(e) forming one of a cathode and an anode of a battery over a side of the composite solid-state electrolyte layer opposite from the porous support layer; and
(f) forming at least a portion of the porous support layer as the other of the cathode and the anode.

20. The method of claim 19, wherein:
the forming of (f) comprises infiltrating the at least a portion of the porous support layer with lithium to form the anode, and
(f) is performed after (d), after (e), or after both (d) and (e).

21-22. (canceled)

23. The method of claim 19, wherein the forming of (f) comprises infiltrating the at least a portion of the porous support layer with one or more cathode active materials to form the cathode.

24. The method of claim 23, wherein the one or more cathode active materials has a composition comprising lithium and another metal element.

25. The method of claim 23, wherein the infiltrating with the one or more cathode active materials comprises disposing one or more cathode active materials with a liquid electrolyte on the porous support layer.

26. (canceled)

27. The method of claim 23, wherein (f) is performed prior to (e), prior to (a), or prior to both (a) and (e).

28. The method of claim 23, wherein the forming of (e) comprises providing a metal film over the composite solid-state electrolyte layer to form the anode.

29. (canceled)

30. The method of claim 23, wherein the forming of (e) comprises:
providing another porous layer over the composite solid-state electrolyte layer; and
infiltrating the another porous layer with lithium to form the anode.

31-32. (canceled)

33. A battery assembly comprising:
a porous support layer; and
a non-porous, composite solid-state electrolyte layer disposed on the porous support layer, the composite solid-state electrolyte layer comprising a porous scaffold and one or more filler materials infiltrating the porous scaffold, the porous scaffold comprising an ion-conducting oxide, the one or more filler materials having a melting point in a range of 500-1100 K, inclusive,
wherein at least a portion of the porous support layer is infiltrated with one or more materials to form an electrode of a battery.

34. The battery assembly of claim 33, wherein:
the at least a portion of the porous support layer is infiltrated with lithium to form an anode of the battery; and
the battery assembly further comprises a cathode of the battery disposed over a side of the composite solid-state electrolyte layer opposite from the porous support layer.

35-36. (canceled)

37. The battery assembly of claim 33, wherein the at least a portion of the porous support layer is infiltrated with one or more cathode active materials to form a cathode of the battery.

38-40. (canceled)

41. The battery assembly of claim 37, further comprising an anode of the battery disposed over a side of the composite solid-state electrolyte layer opposite from the porous support layer.

42-45. (canceled)

46. The battery assembly of claim 33, wherein the porous support layer comprises carbon or a metal.

47-56. (canceled)

57. The method of claim 1, wherein the first temperature is in a range of 1200-3000 K, and the second temperature is less than or equal to about 1200 K.
